(19) United States
(12) Patent Application Publication
(10) Pub. No.: US 2010/0058189 A1
(43) Pub. Date: Mar. 4, 2010

(54) DEVICE AND METHOD FOR CONTROLLING AND MONITORING DOMESTIC TECHNOLOGY DEVICES

(75) Inventors: Klaus-Josef Daffner, Oberursel (DE); Gerhard Heinmoller, Neustadt (DE); Lothar Battefeld, Frankenau (DE)

Correspondence Address: OLIFF & BERRIDGE, PLC, P.O. BOX 320850, ALEXANDRIA, VA, 22320-4850, US

(73) Assignee: VIESSMANN WERKE GMBH & CO. KG, Allendorf (DE)

(21) Appl. No.: 12/449,881

(22) PCT Filed: Nov. 15, 2007
(86) PCT No.: PCT/EP2007/009891

§ 371 Date: Oct. 5, 2009

(30) Foreign Application Priority Data
Mar. 2, 2007 (DE) 10 2007 010 803.8

(51) Int. Cl. G06F 15/16; G06F 3/01; G06F 15/177

(52) U.S. Cl. 715/735; 709/227

(57) ABSTRACT

The invention relates to a device having a network server computer (277) and a controller (276) for controlling a domestic technology device, wherein the network server computer (277) comprises a memory unit (279) for storing at least one website using at least one input means (306-316) for actuating the controller (276), and at least one communication interface (281, 283, 285) for establishing a network connection, via which the website can be retrieved.

In order to enable a transparent and user-friendly control and monitoring of a domestic technology device, the invention provides that the network server computer (277) is integrated at least partially into the controller (276).

The invention relates to a device for controlling and monitoring at least one domestic technology device according to the preamble of claim 1 and to a method for controlling and monitoring at least one domestic technology device according to the preamble of claim 15.

DE 10109196 B4 discloses a device and a method for controlling and monitoring at least one domestic technology device, the device allowing the controlling and monitoring via the internet or a local network. The configuration data of the domestic technology device to be controlled or monitored is stored on a system computer that generates command signals, which are transferred to the domestic technology device via the internet or via the local network, in dependence of the configuration data. The controller has no configurable user interface. The transferred command signals are converted by a protocol converter and transferred to the domestic technology device to be controlled or monitored via a bus system. The domestic technology devices receive the converted command signals and perform the commands encoded therein in dependence of an operating program implemented in advance.

Therefore, the object of the invention is in particular to make a device of the generic kind for controlling and monitoring at least one domestic technology device and a method of the generic kind for controlling and monitoring at least one domestic technology device more user-friendly and more flexible and to simplify in particular the setup of an operating program and/or a particularly graphic user interface on the domestic technology device.

The invention is based on a device having a network server computer and a controller for controlling a domestic technology device, the network server computer comprising a memory unit for storing at least one website using at least one input means for actuating the controller and at least one communication interface for establishing a network connection via which the website can be retrieved.

It is proposed to integrate the network server computer at least partially into the controller. As a result, the communication can take place directly with the controller via the internet or via a local network and a detour via a central control computer, i.e. one located many kilometers away from the controller in a service center and adapted to exchange a communication with a plurality of controllers for domestic technology devices, can advantageously be avoided. This serves for achieving a controller which is operable in a particularly flexible way and can be operated via both the internet and a local network, e.g. of the LAN or Ethernet type. The integration of the web server functionality into the controller enhances the user-friendliness.

In a further development of the invention, it is proposed that the controller comprise a first communication interface for establishing a local network connection and a second communication interface for establishing an internet connection. As a result, the operation can be made even more user-friendly and more flexible since this enables various possibilities for establishing a communication connection and, if applicable, even the possibility of a simultaneous access via the internet and via the local network.

It is also proposed to design the first communication interface as an Ethernet interface. As a result, the controller can be integrated into a flexibly reconfigurable point-to-point network.

If the controller comprises a switching element for starting an automatic setup process in which the controller requests the website from a central setup server computer via the communication interface, the setup can run in largely automated fashion without a user having to intervene in a manner more complex than the mere pressing of the switching element. The switching element can be designed as a push button, for example.

If the controller comprises a time detection unit and is adapted to start the setup process as soon as a user actuates the switching element at least over a predetermined actuation period, it is possible to avoid accidental initiation of the setup process resulting from short pressing onto the switching element.

It is also proposed to adapt the controller to transfer at least one subscriber list of a local network to the central setup server computer in order to start the setup process. This serves for enabling a setup adapted to the subscriber list. In this connection, the term subscriber list comprises in particular a regulator list of heating installation regulators which communicate with the controller of the heating installation via a local network, e.g. an LON network.

The invention also relates to a device for controlling and monitoring at least one domestic technology device, in particular a heating installation, which comprises at least one setup server computer having a memory unit for storing configuration data of the domestic technology device. Here, the setup server computer is in particular adapted to receive at least identification data of a domestic technology device via an internet connection and to read the configuration data of the domestic technology device from the memory unit in dependence of the identification data. The setup server computer generates at least one configuration parameter for a user interface of the domestic technology device in dependence of the configuration data and transfers the at least one configuration parameter to the domestic technology device via a communication connection.

The configuration parameters coming into consideration are in particular sites for a graphic user setting, which may depend on a language selection, for example, initialization files, updates of the software or the pages, in particular the websites of the graphic user interface or parameters which relate to a preferred internet provider.

In order to improve a method of the generic kind, the invention is based on a method for controlling and monitoring at least one domestic technology device, in particular a heating installation, wherein in a method for determining the configuration data and/or regulator list of the domestic technology device the regulator list is retrieved by the domestic technology device and then at least one configuration parameter for a user interface is generated in dependence of the configuration data of the domestic technology device in a user interface configuration step and the configuration parameter of the user interface is transferred to the domestic technology device via a communication connection in a transfer step.

It is proposed to have the user interface configuration step executed by a setup server computer which in an identification step receives identification data of the domestic technology device via an internet connection and reads the configuration data of the domestic technology device from a memory unit at least partially depending on the identification data.

Examples of configuration parameters are e.g. initialization files or also websites, in particular those in HTML, which were generated in dependence of the configuration data and the user requests or downloaded from a directory.

An essential aspect of the invention is to exchange the communication between an input terminal and the domestic technology device in a first setup via a central setup server computer. The input terminal can be designed as a portable computer or also as a web-enabled mobile phone, and a user or maintenance technician who wants to control or monitor the domestic technology device need only have ready the identification data, e.g. a password and a user name or an identification number of the domestic technology device, and pass it on to the setup server computer via the internet connection.

If the domestic technology device is always centrally operated and controlled via the setup server computer and the current configuration data and/or the changes made are always stored in the memory unit, it is also possible to avoid an unclarity on the current configuration of the domestic technology device. The control and monitoring of the domestic technology device by a plurality of users, e.g. by a manufacturer, a maintenance service and an end user, can easily be enabled.

The setup server computer is adapted in particular to receive identification data via an internet connection if it has a web server, e.g. an Apache web server having corresponding http interfaces, and an always reachable, in particular a fixed internet address. The setup server computer is adapted to read data from the memory unit if a driver of the memory unit is installed on the server or if the setup server computer can access the memory unit via a network, e.g. a local network (LAN). The setup server computer is adapted to transfer a configuration parameter for a user interface to the domestic technology device via a communication connection if it has a corresponding interface. Such an interface can be http and ftp interfaces, for example.

In a further development of the invention, it is proposed that the device comprise a program configuration unit for configuring a user interface and/or an operating program or the user interface for a domestic technology device in dependence of the configuration data of the domestic technology device. As a result, it is not only possible to carry out the setup and an update of the current operating program or the firmware via the setup server computer but also to conduct the setup and an update of the graphic user interface via the internet.

According to a further aspect of the invention, the setup server computer is adapted to set up the graphic user interface generated in dependence of the configuration data on the domestic technology device. As a result, the setup is further simplified.

A communication connection optimized in dependence of the setup site and the communication means available at the setup site can be obtained if the setup server computer is adapted to configure an internet access of the domestic technology device via the communication connection. For this purpose, the setup server computer may have a list stored in the memory unit of local internet providers, for example.

If the communication connection is an internet communication connection, a world-wide uniform standard can favorably be used and the communication connection can always be established largely independently of the communication site in an easy way at any time.

If the setup server computer is adapted a form file and to transfer the form file to the user terminal via the internet connection such that the setup server computer provides an internet portal, the user requests can be inquired in a particularly simple way and inputs in a wrong data format can easily be avoided. The form file can be designed as an html file having form function, for example.

The control can be fully based on the internet if the setup server computer is provided to receive a form file supplemented by a user via the internet connection or via a mobile telephony network, e.g. via SMS, and to extract at least one user request characteristic from the form file, the program configuration unit configuring the operating program in dependence of the user request characteristic. User request characteristics in this sense may be a language for the setup of the user program or operating characteristics such as a nominal room temperature in the case of a heating installation, for example. If the device comprises a backup server computer adapted to take over the function of the setup server computer should the latter fail, a safe availability of the control function can be ensured and it is possible to avoid that the domestic technology device can no longer be reached should the primary setup server computer fail.

In an advantageous embodiment of the invention, the device also comprises a monitor computer for monitoring a function of the setup server computer and the backup server computer.

If the setup server computer is adapted to inquire diagnostic data from the domestic technology device via the communication connection, it is possible, in the case of a malfunction, to rapidly and easily detect the cause thereof, in particular via the internet. Errors can be remedied remotely on the basis of the diagnostic data by the generation of a suitable command signal using the setup server computer without a maintenance technician having to be on site. Depending on the kind of error, e.g. a reconfiguration of the operating program or the firmware, an update of the operating program or a new setup of the operating program can be made remotely. A large number of configuration data of the graphic user interface can be managed in a transparent manner if the device has a database comprising the memory unit. For example, a database of the MySQL type is in consideration as the database.

The method according to the invention for controlling and monitoring at least one domestic technology device, in particular a heating installation, is based on a method in which at least one configuration parameter for a user interface is generated in dependence of the configuration data of the domestic technology device in a user interface configuration step and the configuration parameter or files for a graphic user interface are transferred via a communication connection to the domestic technology device in a transfer step.

It is proposed that the user interface configuration step be carried out by a setup server computer which receives identification data of the domestic technology device via an internet connection in an identification step and reads the configuration data of the domestic technology device at least partially depending on the identification data of the memory unit or requests it from the domestic technology device. As a result of the allocation according to the invention of the user interface configuration step to a setup server computer, the necessary computing and storage capacities can be provided in this setup server computer and the operation, control and/or monitoring, conveyed by the setup server computer, can be conducted by any input terminal.

Further advantages of the invention follow from the below description of the attached drawings. The figures, the claims and the description contain numerous features in combination which a person skilled in the art will also consider separately and combine them into useful further combinations.

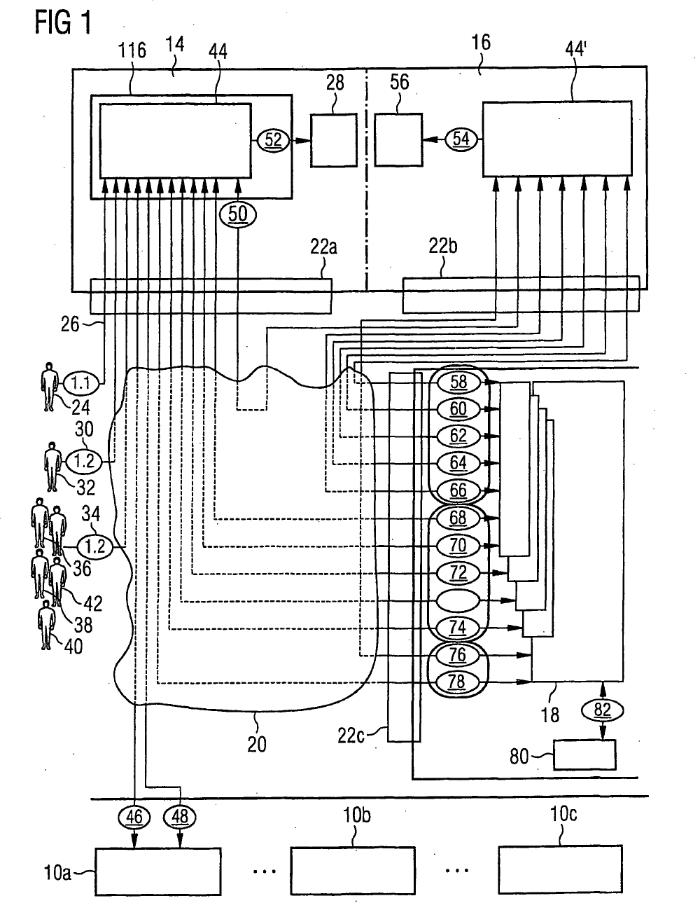

FIG. 1 shows a schematic diagram of a device for controlling and monitoring several heating installations;

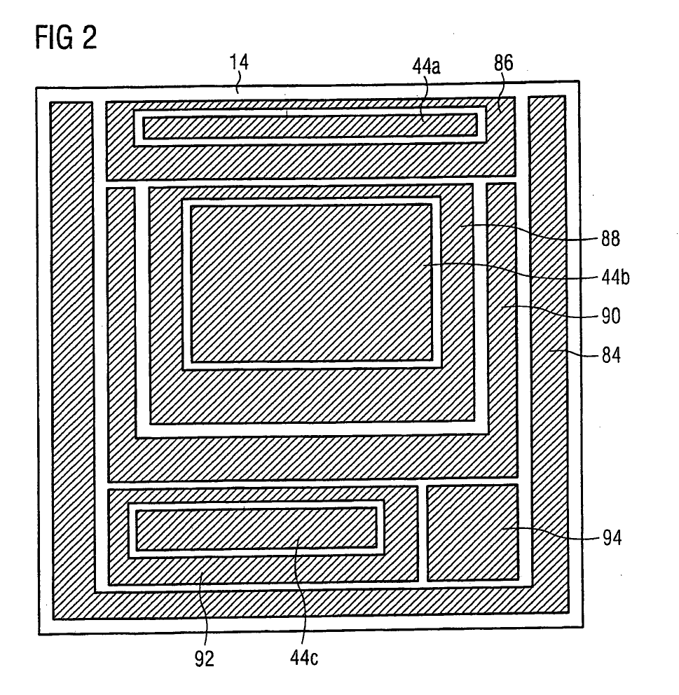

FIG. 2 shows the schematic design of a setup server computer of the device according to the invention;

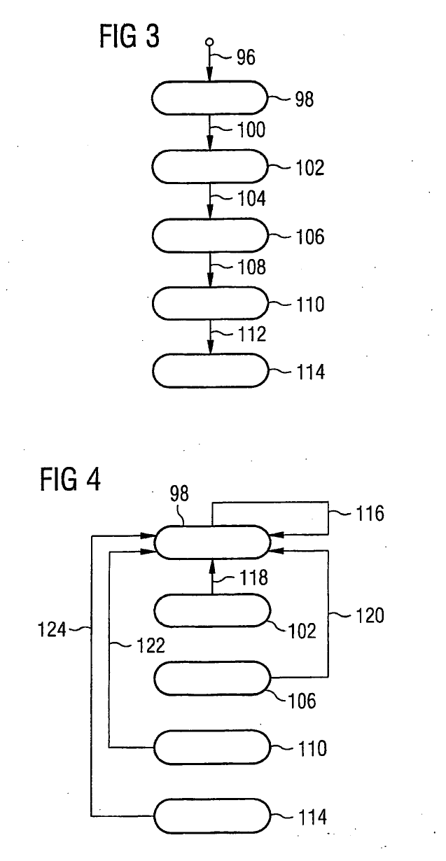

FIG. 3 shows a flow chart of a normal life cycle of a controller of a heating installation;

FIG. 4 shows a diagram with respect to possible transitions to a first, initialized state of the controller of the heating installation;

FIG. 5 shows a diagram with respect to possible transitions to a second, activated state of the controller of the heating installation;

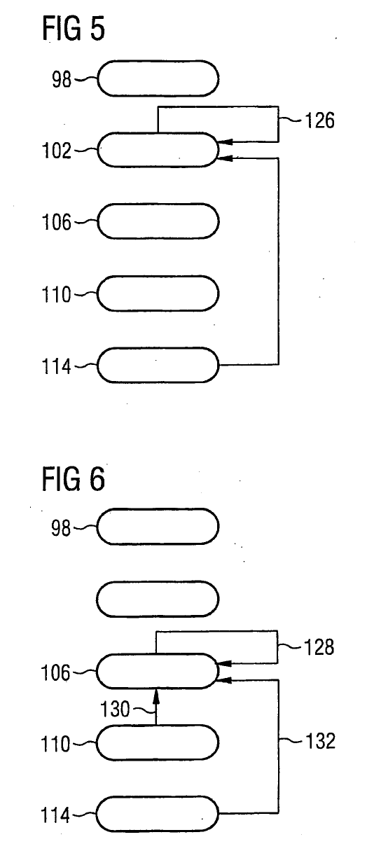

FIG. 6 shows a diagram with respect to possible transitions to a third state of the controller of the heating installation, in which a setup is prepared;

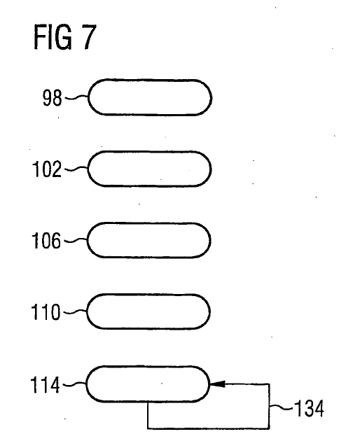

FIG. 7 shows a diagram with respect to a possible transition to a fifth state of the controller of the heating installation in which the heating installation is put into operation;

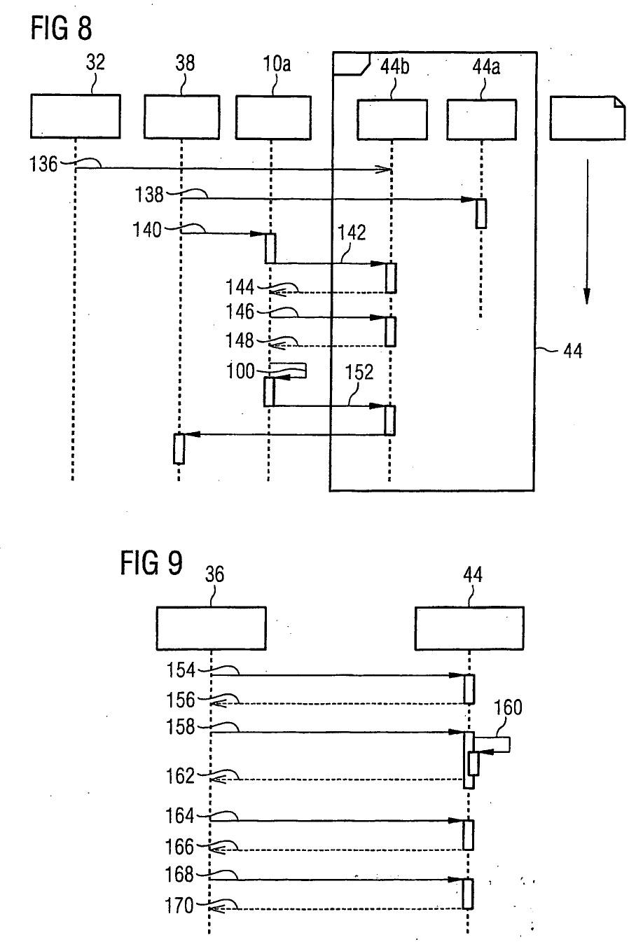

FIG. 8 shows a sequence diagram of a normal life cycle of a controller of the heating installation;

FIG. 9 shows a sequence diagram with respect to a software upload and a software activation of the controller of the heating installation;

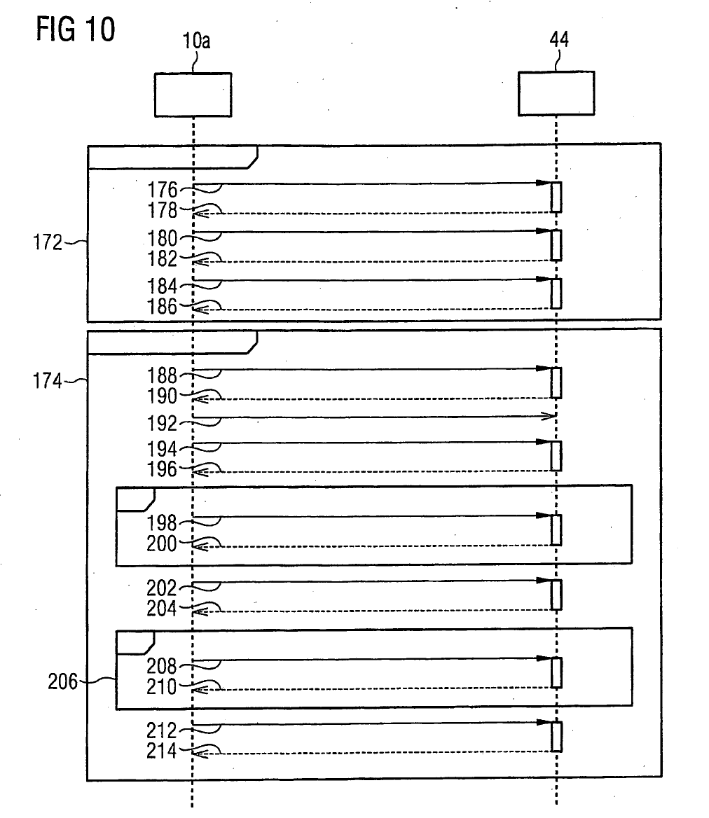

FIG. 10 shows a sequence diagram of an entire setup process for setting up an operating program on the controller of the heating installation;

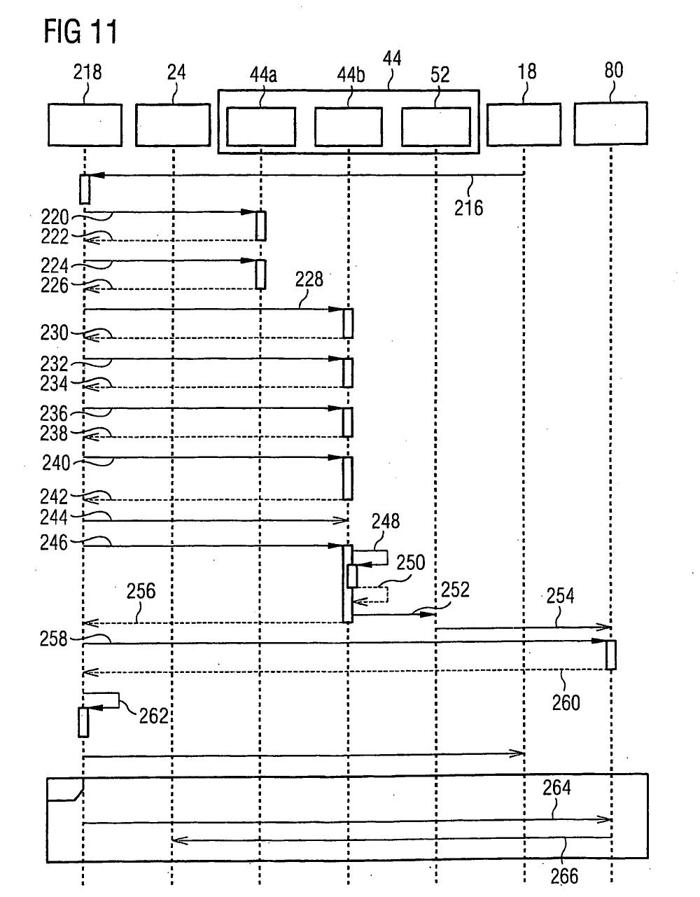

FIG. 11 shows a diagram with respect to a monitoring sequence for testing a setup portal on the setup server computer according to FIG. 2;

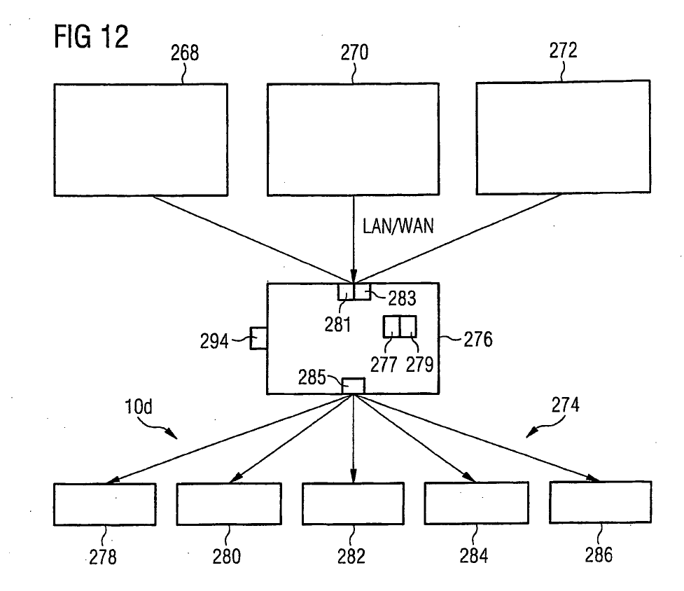

FIG. 12 shows a device for controlling and monitoring a heating installation according to an alternative embodiment of the invention;

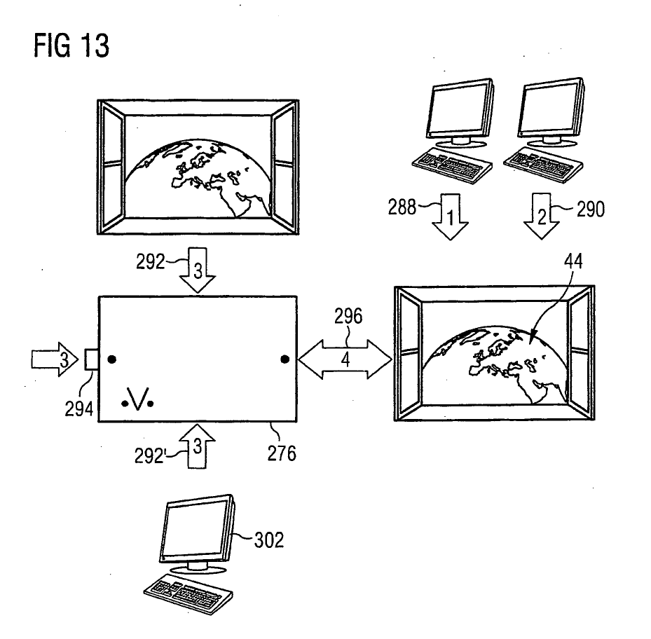

FIG. 13 shows a flow chart for setting up an operating program and a user interface with websites of a controller of a heating installation according to FIG. 12;

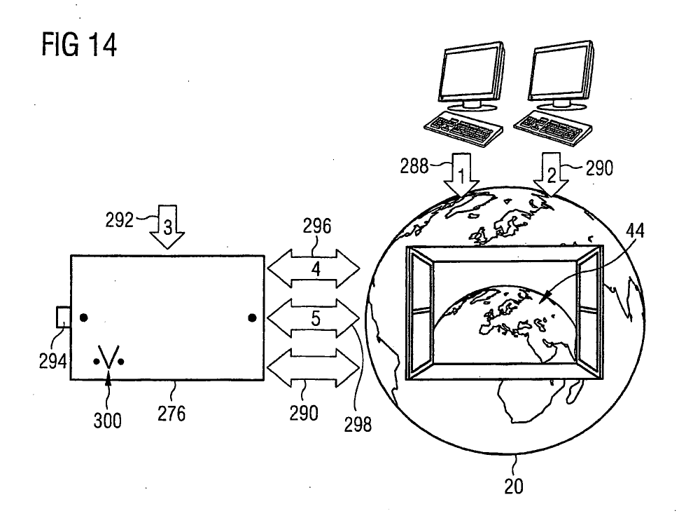

FIG. 14 shows a flow chart of controlling and monitoring the controller of the heating installation according to FIGS. 12 and 13;

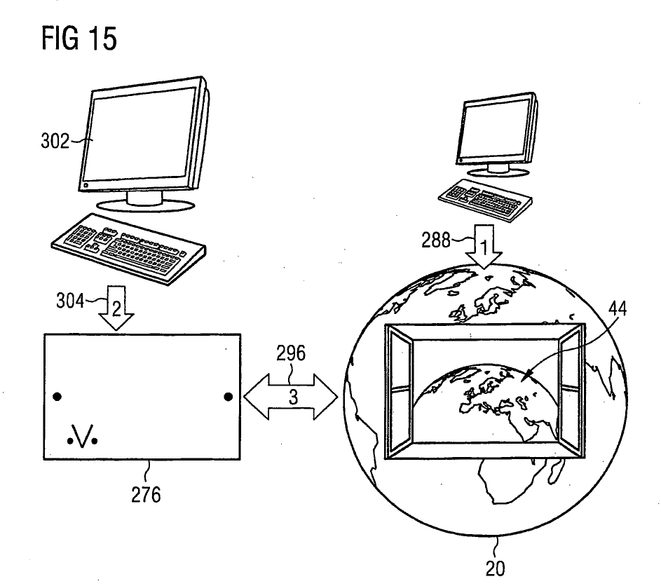

FIG. 15 shows a diagram with respect to an alternative setup possibility for the operating program in the controller of the heating installation according to FIGS. 12 to 14; and

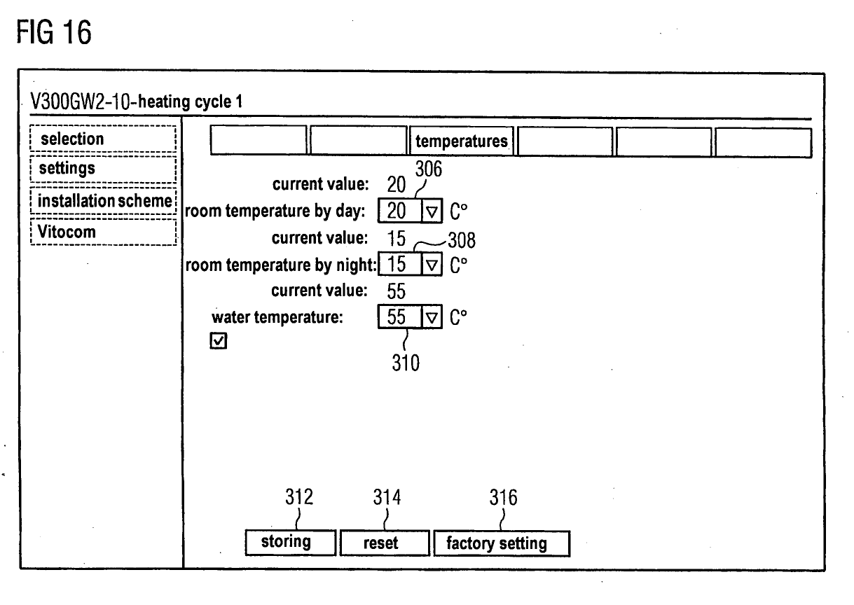

FIG. 16 shows a website stored on a network server computer for actuating a domestic technology device.

FIG. 1 schematically shows a device for controlling and monitoring a plurality of domestic technology devices 10a to 10c, which in the embodiment as shown are designed as heating installations having programmable controllers. The device comprises a first setup server computer 14 designed as a live server, a second setup server computer designed as a backup server computer 16 whose configuration is a mirror image of the configuration of the setup server computer 14 and a monitor computer for monitoring the function of the setup server computer 14 and the backup computer 16.

The domestic technology devices 10a to 10c, the setup server computer 14, the backup server computer 16 and the monitor computer 18 communicate via the internet 20 and for this purpose are equipped with the necessary modems and interfaces, which are specified below. The setup server computer 14, the backup server computer 16 and the monitor computer 18 are each connected to the internet 20 via a firewall 22a to 22c and protected by it. The setup server computer 14 communicates with a system administrator 24 via the internet 20 using a secured data connection 26 which is a secure shell SSH in the present embodiment; the SSH interface serves for administering a setup portal described in detail below by a system administrator on the shell level. The system administrator 24 can set up software or software supplements and updates via the SSH interface and/or communication connection 26 within the frame of the operation of the setup portal. This may concern both operating system-related software components and software components of the setup portal. Furthermore, via the communication connection 26 the system administrator 24 can operate a monitoring system which monitors the availability of the setup portal. The system administrator can check selected business processes of the setup portal or the setup server computer 14 for operability by means of monitoring means in the setup server computer 14, e.g. by means of monitoring scripts. In addition, the system administrator may operate a mail server 28. The mail server 28 of the setup server computer 14 serves e.g. for informing a heating fitter by e-mail on the outcome of a setup program of an operating program on a domestic technology device 10a to 10c. In the case of damage or maintenance of the setup server computer 14, the system administrator 24 can also activate the backup server computer 16 via the secured communication connection 26 to ensure the further availability of the setup portal. Moreover, the system administrator 24 can generate a backup of the configuration, master and movement data of the setup portal via the secured communication connection 26 in manual or automated fashion to provide protection from a data loss resulting from a case of damage.

Furthermore, the setup server computer 14 communicates with a supplier of the controller of the domestic technology device 10a-10c via a file transfer protocol (ftp) interface 30. The ftp interface 28 serves for transferring a file containing the device information from the hardware supplier 30 to the setup server computer 14. The hardware supplier 30 can transfer the information necessary for the setup of the operating software or the operating program, such as a serial number, an activation key and a device type, to the setup server computer 14 via the ftp interface 28. Moreover, the hardware supplier 30 can read the status of the hardware produced by him or her by means of the serial number, for example. Further groups of persons, e.g. the system administrator 24, the hardware supplier 32, a software supplier 36, a heating fitter 38, a support service 40 as well as an end user 42, can access the web interfaces of the setup portal 44 on the setup server computer 14 via an internet interface 34 available to the hardware supplier and designed as an http interface in the embodiment. The setup server computer 14 communicates with each of the domestic technology devices 10a to 10c via the internet 20 and one http interface 46 each to exchange commands between the domestic technology devices 10a to 10c and the setup portal 44 and via an ftp interface 48 to transfer files from the setup server computer 14 to the domestic technology device 10a to 10c. In FIG. 1, the http interface 46 and the ftp interface 48 are only exemplified at the first domestic technology device 10a but are available with identical design at the other domestic technology devices 10b and 10c.

The setup server computer 14 and the backup server computer 16 communicate via a secure shell interface 50 to secure the data backup of the setup portal 44 in a copy 44′ of the setup portal. The setup portal 44 communicates with the mail server 28 via an smtp interface 52.

In analogy, copy 44′ of the setup portal on the backup server computer 16 communicates with a mail server 56 of the backup server computer 16 via a further smtp interface 54.

The monitor computer 18 communicates with the backup server computer 16 via an http interface 58 to check the web server accessibility of copy 44′ of the setup portal; the monitor computer 18 controls the data exchange by the execution of the below described monitoring scripts via an ftp interface 60. The monitor computer 18 checks the access to a database of copy 44′ of the setup portal via a TCP interface 62; an snmp interface 64 serves for system-monitoring (e.g. of the CPU load, the hard disk capacity, etc.) the backup server computer 16 of copy 44′ of the setup portal and the icmp interface 66 serves for checking the accessibility of the backup server 16 in copy 44′ of the setup portal. An http interface 68 of the monitor computer 18 corresponds to the http interface 58 and serves for checking the web server accessibility of the setup portal 44 by the execution of the monitoring scripts. An ftp interface 70 serves for controlling the data exchange resulting from the execution of the monitoring scripts transferred from the monitor computer 18 to the setup server computer 14. A TCP interface 72 corresponds to the TCP interface 62 and serves for checking the access to a database of the setup portal 44; an snmp interface serves for monitoring the CPU load and the hard disk capacity of the setup server computer 14, and an icmp interface 76 serves for checking the accessibility of the setup server computer 14 of the setup portal 44. An ssh interface 76 serves for checking the shell access to the backup server computer 16 of copy 44′ of the setup portal and an ssh interface serves for checking the shell access to the setup server computer 14 of the setup portal 44. Furthermore, the monitor computer comprises a mail server 80 having a POP3 interface 82 for receiving e-mails by the tests triggered by the monitor scripts.

FIG. 2 schematically shows the design of the setup server computer 14 including the setup portal 44. The backup server computer 16 is designed identically to the setup server computer 14. The setup portal 44 consists of three essential parts, namely a collection of html pages 44a, a collection implementing dynamic business logic of applications 44b and a database 44c. In the present embodiment, all three parts 44a to 44c of the setup portal 44 are implemented in a single setup server computer 14 which runs under an operating system 84, e.g. Linux. The html pages 44a of the setup portal 44 are provided via a web server 86 developed as an Apache server of the setup server computer 14; the applications 44b of the setup portal 44 run on an application server 88 which in turn runs in a secured environment 90, e.g. in a JAVA runtime environment JRE. The database 44c of the setup portal 44 is integrated into a database program 92, e.g. MySQL. Periodically recurring cron jobs and monitoring scripts are performed in a background program 94. FIG. 3 shows the normal life cycle of a controller of a domestic technology device 10a to 10c. In a first step 96, the controller is initialized and thus converted into a first state 98. Based on the first state 98, the controller is activated in a step 100 and thus converted into a second state 102. Based on the second state 102, the controller is prepared for setup in a preparation step 104, thus being converted into a third state 106. In a setup step 108, an operating program is installed on the controller and the controller is thus converted into a fourth state 110. In a further step 112, the controller is put into operation, thus being converted into an operating state 114.

In the first step 96, the hardware supplier 32 uploads a file which contains the important data of the controller to the setup portal 44 via the ftp interface 30 (cf. FIG. 1). In state 98 there is thus a set of data including the serial number, an activation key, a device type and further additional data of the controller of the domestic technology device 10a to 10c in the database 44c of the setup portal 44. A state characteristic of the controller is set to “initialized” and to the top in the database 44c.

In the second step 100, the heating fitter logs on via the http interface 34 of the setup portal 44 using the serial number enclosed to the controller of the domestic technology device 10c in its scope of supply and an activation key. After the successful log-on, he or she can input or configure the entire data relevant for the setup process, such as the language of the software, the standard of the controller (the setup country), the self-defined internet service provider, an e-mail address, etc. For this purpose, the web server 86 provides corresponding html pages from the collection of html pages 44a, which are formed as form files and transferred to a user terminal of the heating fitter via the http interface 34. The user, i.e. in the present case the heating fitter 38, can enter the desired data into the form fields of the form file and transfer it to the setup server computer 14 via the http interface 34. Alternatively, the heating fitter 38 can transfer the necessary data to the setup server computer via a mobile telephony network, e.g. by SMS. The setup server computer can extract user request characteristics from the transferred, supplemented form files and, as described below, configure the operating program of the controller of the domestic technology device 10a to 10c in dependence of the user characteristic. The user request characteristics may contain in particular the language, the location of the domestic technology device 10a to 10c, self-defined internet service providers, e-mail addresses, mobile telephony or telephone numbers, etc. In the second state 102, all data necessary for the software setup on the controller of the domestic technology device 10a to 10c are stored in the database 44c of the setup portal 44 on the setup server computer 14 and on a memory unit 116 of the setup server computer, respectively. A state characteristic of the controller of the corresponding domestic technology device is “activated” in the database 44c of the setup portal 44.

In the preparation step 104, the controller of the domestic technology device is in a state in which all regulators are connected and the communication interfaces 46, 48 of the domestic technology device 10a to 10c are connected to the internet. When the heating fitter 38 actuates a maintenance button (not shown), the setup process is triggered on the controller of the corresponding domestic technology device 10a to 10c. The controller or the domestic technology device 10a to 10c logs on the setup portal 44 via the http interface 46 and downloads all configuration data relevant for the setup process (e.g. concerning the internet access) via the ftp interface 48 of the setup portal 44. After a successful download of the data, the controller logs off the setup portal 44 and disconnects the connection.

In the third state 106, the state of the controller or the corresponding domestic technology device 10a to 10c is set to “setup prepared” in the database 44c of the setup portal 44.

The controller of the corresponding domestic technology device 10a to 10c establishes a current regulator list in the setup step 108 in which it checks which regulators have been connected. Then, the controller is automatically connected to the internet in accordance with its configuration and logs on the setup portal 44 via the http interface 46. Having transferred the list of all connected regulators to the setup portal 44 via the ftp interface 48, the setup portal 44 compiles in accordance with the configuration data set for the device, such as language, connected regulators and device type as well as the further configuration data stored by the hardware producer 32 in the database 44c, all necessary software components and prepares them for download. The controller of the domestic technology device 10a to 10c makes cyclic requests regarding the status or the presence of the also generated list using ftp commands which address the download of all required files. When the setup portal 44 has compiled all software components and the job list has been generated, the controller of the domestic technology device 10a to 10c downloads the job list via the ftp interface 48 of the setup portal 44.

Having concluded the ftp download of the job list, the controller of the domestic technology device 10a to 10c starts to work through the job list as a result of which it downloads all necessary software components from the setup portal. Having successfully downloaded all software components, the domestic technology device 10a to 10c logs off the setup portal via the http interface 46.

In the fourth state 110, the execution of the entire setup sequence is complete. The state of the corresponding domestic technology device 10a to 10c is set to “set up” in the database 44c of the setup portal 44.

In step 112, the controller of the domestic technology device 10a to 10c which has downloaded the software components according to the job list, automatically carries out a restart. After the successful and proper restart with the installed and configured software, the controller of the domestic technology device 10a to 10c logs on the setup portal 44 via the http interface 46 and reports that it has started its operation. On account of this report of success by the domestic technology device 10a to 10c, the setup portal 44 sends an e-mail or an SMS to all preconfigured e-mail addresses or mobile telephony numbers which the heating fitter 38 has inputted via the form files. For this purpose, it uses the smtp interface 52 and the mail server 28 or a GMS or GPRS modem. Alternatively, the controller can also comprise a GPRS modem and by using the same send the report of success to the setup portal or to preconfigured recipients.

In operating state 114 the setup portal 44 has received a confirmation of the successful restart of the domestic technology device 10a to 10c and, in dependence on the existence of the configured e-mail addresses, has sent one or more e-mails to the addresses deposited by the heating fitter 38.

In the database 44c of the setup portal 44 the state of the domestic technology device 10a to 10c in question is set to “operating”. In deviation from the normal life cycle of a controller of a domestic technology device 10a to 10c described with reference to FIG. 3, there are transitions between the states 98, 102, 106, 110, 114 which are described below with reference to FIGS. 4 to 7.

FIG. 4 shows various possibilities by which the controllers of a domestic technology device 10a to 10c are put into the first state 98. At first the hardware supplier 32 can transfer updated data of the controller to the setup program 44 via the ftp interface 30. An already existing set of data of the controller is deleted in the memory unit 116 and in the database 44c of the setup portal 44, respectively, and a new set of data for the corresponding controller or the corresponding domestic technology device 10a to 10c is created in a step 116. Such update may be due to the fact that after the controller has already been initialized it once again is passed through a test run of the hardware production.

If such update of the data is made by the hardware supplier 32 while the domestic technology device 10a to 10c is in the second state 102, in the third state 106, in the fourth state 110 or in the fifth state 114, the data already registered under the serial number in the database 44c are logically deleted with all referencing data and a new set of data is created. The controller or the domestic technology device 10a to 10c is initialized in steps 118 to 124 in an analogue manner to step 96. Such initialization may be performed, for example, if the controller of the domestic technology device 10a to 10c returns to the hardware production after a malfunction in the field and is successfully repaired and brought back into circulation.

If the controller had already been activated the heating fitter 38 must possibly enter the configuration data again (for example, voice settings, e-mail address, internet service provider, configuration data, etc.).

FIG. 5 shows possible transitions into the second state 102 which may occur in deviation from the normal life cycle. If a controller or if a domestic technology device 10a is already in the activated state 102 and the heating fitter 38 logs on the setup portal 44 via the http interface, he or she may perform changes on the existing configuration data. The configuration data of the controller already stored in the database 44c on the memory unit 116 of the setup server computer 14 are logically deleted and the new data of the controller are stored in a step 126 which converts the state 98 into itself. This case may occur, for example, if the heating fitter 98 has entered the configuration data in an erroneous manner (for example, if he or she has selected the wrong language or the wrong internet service provider data, etc.) so that it is necessary to correct the configuration data.

FIG. 6 shows possible transitions into the third state 106 in which the setup has been prepared, which may occur in deviation from the normal life cycle of the controller of a domestic technology device 10a to 10c. In this state 106, all regulators are connected and the controller is connected to the internet 20 via the corresponding communication interfaces 46, 48. If, for example during the course of the setup sequence, either a power failure has occurred on the domestic technology device 10a to 10c or if the heating fitter 38 has disconnected the controller or domestic technology device 10a to 10c from the power supply and after that actuated the maintenance button again so as to effect another start of the setup sequence, the controller is converted into the preparation state 106 in a step 128 which converts the state 106 into itself or, if the domestic technology device 10a to 10c had already been in the state 110 or the operating state 114, it is reset to state 106 in step 130 and 132, respectively.

FIG. 7 shows a possibility how the controller can be converted from the normal life cycle shown in FIG. 3 into the operating state 114 in deviation from step 112. If the controller is disconnected from the power grid by the heating fitter 98 or a power failure occurs, the controller starts up again after the disconnection from the grid has ended and restores operating state 114 in a step 134. FIG. 8 shows a sequence diagram of the normal life cycle shown in FIG. 3 of a controller of a domestic technology device 10a and the interaction of the hardware producer 33, the heating fitter 38 and the domestic technology device 10a, which is exemplarily illustrated for all domestic technology devices controlled via the setup portal, with the setup portal 44. In a step 136 the hardware producer initializes the controller of the domestic technology device 10a in a part 44b of the setup portal 44, which cannot be accessed via the html pages 44a and runs in the background. During the course proceeding vertically downwards in FIG. 8 the heating fitter 38 activates the controller 10a in a step 138 corresponding to step 100 in FIG. 3 and for this purpose uses an access via the html pages 44a of the setup portal. Subsequently, in a step 140, the heating fitter 38 presses a maintenance button of the controller of the domestic technology device 10, thus triggering the automatically running step 142 which corresponds to step 104 in FIG. 3 and in which the setup is prepared. In a step 144 the controller of the domestic technology device downloads the list of possible internet service providers, logs on the setup portal in a step 146 and loads the required software components via the ftp interface 48 in a step 148 in dependence of the configuration data of the domestic technology device 10a filed in the database 44c. In a step 150, the domestic technology device 10a restarts and in a step 152 reports the successful start-up to the setup portal 44. The setup portal 44 forwards the report on the successful start-up to the heating fitter 38 via the mail server 28.

FIG. 9 shows the interaction of a software producer 36 with the setup portal 44 via the http interface 34. In a step 154 the software producer 36 logs on the setup portal 44 and receives a feedback on the successful log-on in a step 156. In a step 158 the software producer 36 can upload software onto the setup portal 44 via an http upload. In a step 160 the setup portal 44 stores the software components uploaded in step 158 in the memory unit 116 of the setup server computer 14. In doing so, the setup portal 44 prepares the received data to provide them for setup.

In a step 162 the setup portal 44 confirms the successful file upload to the software producer 36.

In a step 164 the software producer 36 selects the software version to be activated in a form and sends the form to the setup portal 44. The setup portal 44 updates the database so that the activated version of the software component can be offered for download. In a step 166 the setup portal confirms the successful activation to the software producer 36.

In a step 168 the software producer 36 logs off the setup portal 44 and in a step 170 the successful log-off is confirmed.

FIG. 10 shows a sequence diagram of an entire setup process, which corresponds to step 108 in FIG. 3. The setup process comprises a preparation part 172 and an actual 172 and an actual setup part 174. In the preparation part 172 the controller of the domestic technology device 10a logs on the setup portal 44 via the http interface in a step 176. In a step 178 the setup portal 44 reports back the successful log-on to the controller of the domestic technology device 10a. In a step 180 the setup portal 44 downloads the configuration data from the controller of the domestic technology device 10a via the ftp interface 48 and confirms the successful data transfer in a step 182. In a step 184 the controller of the domestic technology device 10 logs off the setup portal 44 which confirms the successful log-off in a step 186.

For the actual setup the controller of the domestic technology device 10 logs on the setup portal 44 in a step 188 which confirms the successful log-on in a step 190. In a step 192 the controller of the domestic technology device 10a uploads a regulator list to the setup portal, which list comprises a number and a type of regulators connected to the controller and thus configuration data in the field. When the upload of the regulator list is complete, the controller of the domestic technology device 10a reports this to the setup portal 44 in a step 194, which confirms the receipt of the complete regulator list in a step 196.

In a step 198 the domestic technology device 10a inquires whether there is a job list at the setup portal 44 and receives a positive or negative response in a step 200. If there is a job list the domestic technology device 10a requests the same in a step 202 and the setup portal 44 passes the job list on to the domestic technology device 10a in a step 204. In a loop 206 a step 208, in which the domestic technology device 10a request a file according to the job list, and a step 210, in which the setup portal 44 transfers a file to the domestic technology device 10a via the ftp interface 48, are repeated until the job list has been worked through. In a step 212 the domestic technology device 10a logs off the setup portal 44 and the setup portal 44 confirms the successful log-off in a step 214.

A diagram of a monitoring sequence running on a monitoring computer. In a first step 216 the monitor computer starts a monitor script on the setup server computer 14 via the ssh interface 78. To this end, the monitor server 18 dials in at the setup server computer 14 as a monitoring user 218 the http interface 68 in a step 220. The setup server computer 14 confirms the log-on in a step 222. In a step 224 the monitoring user 218 passes an activation inquiry on to the setup server computer 44. The latter confirms the activation in a step 226. In a step 228 the monitoring user 218 logs on a back-end of the setup portal 44. The log-on is confirmed in a step 230. In a step 232 the monitoring user confirms the inquiry for a configuration file to the back-end of the setup portal. The configuration file is downloaded in a step 234.

In a step 236 the monitoring user logs off the back-end and the business logic part 44b of the setup portal, respectively, and the log-off is confirmed in a step 238. In order to check an upload function the monitoring user again logs on the back-end 44b of the setup portal 44 and the log-on is confirmed in a step 242. In a step 244 the monitoring user passes an ftp upload command on to the setup portal 44 and confirms the complete upload of a regulator list in a step 246. In a step 248 the setup portal 44 checks the regulator list and evaluates it. If the regulator list is faulty, a corresponding classification is made in a step 250. In this case the setup portal generates an error message in a step 252 and sends it back to the monitoring computer 18 simulating a heating fitter via the smtp interface 52 via the mail server 28, the mail server 80 and the smtp interface 82 in a step 254. At the same time the setup portal creates a error signal via the http interface 68 in a step 256. In a step 258 the monitoring user 218 fetches its e-mails from the mail server 80 and receives the e-mail from the setup portal 44 via the smtp interface 82 in a step 260 if the regulator list was faulty. In a step 262 the monitor computer as the monitoring user evaluates the received e-mail and passes a monitoring report on to the monitor computer 18. If a fault has occurred, the monitor computer 18 generates an e-mail and sends it to the mail server 18 in a step 264, and the latter delivers it to the system administrator 24 in a step 266

FIG. 12 shows an alternative embodiment of the invention including a domestic technology device 10d which comprises a controller 276 and a plurality of individual regulators 278 to 286. The controller 276 communicates with the individual regulators via a field bus system 274 of the local operating network (LON) type.

The controller 276 comprises an integrated network server computer 277 implemented as software, which is equipped with a memory unit 279 for storing websites. The websites form a user portal including HTML forms which comprise at least one input means—that is, for example, a button, a selection menu, an input text field or the like. The controller 276 can be actuated via the website, i.e., it can be controlled or regulated. For example, the user can have nominal room temperatures for the rooms to be heated in which the individual regulators 278 to 286 are disposed.

FIG. 16 exemplarily shows a website for controlling the domestic technology device via the controller 276. The website contains three input means 306-310 formed as selection menus for inputting control parameters of a particular regulator 278-286. Furthermore, there are three input means 312-316 formed as buttons for storing and resetting the selected control parameters and for selecting the factory setting, respectively.

The websites as a whole are divided in a group concerning basic functions, a group concerning extended functions, a group concerning configuration data and a group concerning an alarm handler.

The group concerning configuration data particularly allows the input of the WAN and LAN settings, the e-mail provider, the user management and the date and time.

Furthermore, the controller 276 comprises three communication interfaces 281, 283, 285 for establishing network communications via which the websites can be retrieved.

A first communication interface 281 designed as an Ethernet card or Ethernet interface for establishing a local network connection (LAN) and enables the comfortable integration into an intranet.

A second communication interface 283 for establishing an internet connection and a general wide area network (WAN) connection, respectively, can be formed as a serial port having 115200 baud with hardware handshake signals RTS, CTS, DTR, and DSR. Possible embodiments of the invention comprise a connected internal analogue modem having 56k, an ISDN terminal adapter without channel bundling or a GSM/GPRS modem having 9600 bps in GSM or GPRS class 2.

The user can remotely dial in via the communication interface 283 by point-to-point protocol (PPP) and must provide authentication by user name and password. An authentication takes place via PAP or CHAP. This authentication simultaneously serves as basic authentication for access to the websites. As a result, remote access via the telephone number of the controller 276 is possible.

The two communication interfaces 281, 283 offer the possibility of simultaneous access via the telephone line and via the local network (LAN).

Instead of the Ethernet interface 281, another interface, for example a W-LAN interface having a corresponding converter, an analogue modem, an ISDN terminal adapter, a GSM modem or GPRS modem or the like, may be provided for remotely operating the controller 276.

The third communication interface 285 is used for communication with the regulators 278-286 via a LON bus system according to ANSI/EIA-709.x and EIA-852 as well as according to EN14908. It makes a neutral exchange of information between regulators 278-286 and the controller 276 possible. The communication interface 285 is provided by a neuron microcontroller. A TP/FT-10 able transceiver is connected to the neuron microcontroller. The transceiver takes over all tasks for the LON communication.

The controller 276 takes over the functionality of a network server computer which is thus completely integrated in the controller 276. As a result, communication can take place directly with the controller 276 via the internet or via a local network and a detour via a central setup server computer, i.e. which is located many kilometers away from the controller, and which is adapted to exchange communication with a plurality of controllers for domestic technology devices, can advantageously be omitted. Thus, a controller 276 which can be operated in a particularly flexible manner is achieved that may be operated via the internet as well as via a local network, for example, of the LAN or Ethernet type. By integrating the web server functionality into the controller 276 it is possible to enhance the user-friendliness of the entire installation.

Furthermore, the controller includes a switching element or a maintenance key 294 for starting an automatic setup and/or maintenance procedure in which the controller requests the website from a central setup server computer via the communication interface and downloads it, for example, via an ftp connection. The setup of the user portal, which is formed by the downloaded websites, will then run in largely automated fashion without a user having to intervene in a manner more complex than the mere pressing of the maintenance key 294.

Furthermore, it is proposed that for starting the setup process the controller transmit at least one subscriber list of a local network to the central setup server computer. Thus, a setup adapted to the subscriber list can be made possible. The term subscriber list in this connection particularly comprises a regulator list of regulators of a heating installation which communicate with the controller of the heating installation via a local network, for example, an LON network.

The setup process of the controller 276 of FIG. 12 is schematically shown in FIG. 13. In a step 288 a serial number and an access code of the domestic technology device 10d or the controller 276 are stored subsequently to the production in the database 44c of a setup portal 44. In a second step 290 the controller 276 has reached a heating fitter 38 and must be registered in the setup portal 44. To this end, an instruction leaflet on which the portal name and the internet address, respectively, of the setup portal 44 and the access data are listed is enclosed to the controller 276. The heating fitter 38 logs on the setup portal 44 and signs on the controller 276 of the domestic technology device 10d. This sign-on includes the language selection, the country in which the controller 276 is installed as well as some indications for establishing a connection and the type of the controller 276. For accessing the controller 276 the heating fitter 38 can furthermore enter a telephone number of the controller 276. Moreover, after the controller 276 has been registered, the heating fitter can arrange it for an internet access of its own which functions in parallel to the serial number and the access code.

In a third step 292 the controller 276 is electrically installed and connected to the telecommunications network. In order to start the setup a maintenance key 294 is pressed for ten seconds. For measuring the time interval in which the maintenance key 294 is pressed, the controller 276 comprises a time detection unit and is adapted to start the setup process if a user actuates the switching element at least over a predetermined actuation period, so that it is possible to avoid an accidental initiation of the setup process resulting from short pressing onto the switching element or the maintenance key 294.

In a fourth step 296 the controller 276 dials into the internet 20 via an internet provider set up by the heating fitter 38 beforehand and logs on the setup portal 44. The setup portal 44 immediately provides the controller 276 with a selection of local internet providers by means of the serial number. The connection is disconnected after the shortest possible time.

FIG. 14 shows another course of the setup process. In a fifth 298 the controller 276 dials into the internet 20 via a local provider and into communication with the setup portal 44. The setup portal 44 equips the controller 276 with all necessary data and induces a restart. In a further step 290 the controller 276 dials into the internet 20 for a last time after the restart and reports the successful setup to the setup portal 44.

Should the fourth step 296 fail, this has to be shown to the user or heating fitter 38 by means of a suitable flashing code. To this end, the controller 276 comprises signal lamps 300. Depending on the flashing code the user can recognize what was the cause for the error. Possible reasons are, for example, that the controller 276 had not been logged on the setup portal 44, that the controller 276 could not establish a telephone connection or that the controller 276 was not able to conduct a successful negotiation with an internet provider stored by the heating fitter 38.

In addition, the entire setup procedure can be remotely started. To this end, the step 292 of FIG. 13 in which the heating fitter 38 performs the logical setup of the controller 206 can be replaced by a step 292′ (cf. FIG. 13) in which the logical setup is performed via a remote procedure call (RPC). The message that the maintenance button 294 was pressed for ten seconds and thus the dialing into the setup portal 44 is to take place can also be made via RPC. In this case, the controller must send all possible success and failure reports to the computer 302 (cf. FIG. 13) that has delivered the remote procedure call.

A setup simplified in this manner is schematically shown in FIG. 15. In a first step 288, as before, the controller 276 is set up in the setup portal 44. The logical setup by the heating fitter 38 and the pressing of the maintenance key 294 in step 292 is replaced by a single remote procedure call 304 from the computer 302 and in a step 296 the controller 276 of the domestic technology device 10d dials into the setup portal 44 on a remote setup server computer 14 via the internet 20.

1. A device having a network server computer and a controller for controlling a domestic technology device, wherein the network server computer comprises a memory unit for storing at least one website using at least one input means for actuating the controller, and at least one communication interface for establishing a network connection, via which the website can be retrieved, wherein the network server computer is integrated at least partially into the controller.

2. The device according to claim 1, wherein the controller comprises a first communication interface for establishing a local network connection and a second communication interface for establishing an internet or telephone connection.

3. The device according to claim 2, wherein the first communication interface is formed as an Ethernet interface.

4. The device according to claim 1, wherein the controller has a switching element for starting an automatic setup process in which the controller requests the website from a central setup server computer via the second communication interface.

5. The device according to claim 4, wherein the controller comprises a time detection unit and is configured to start the setup process if a user actuates the switching element at least over a predetermined actuation period.

6. The device according to claim 4, wherein the controller is provided to transfer at least one subscriber list of a local network to the central setup server computer to start the setup process.

7. A device for controlling and monitoring at least one domestic technology device, in particular a heating installation, comprising:
at least one setup server computer having a memory unit for storing configuration data of the domestic technology device,
characterized in that the setup server computer is configured
to generate at least one configuration parameter for a user interface of the domestic technology device in dependence of the configuration data, and
to transfer the at least one configuration parameter to the domestic technology device via a communication connection.

8. The device according to claim 7, further comprising means for establishing a communication connection between the setup server computer and at least one of the domestic technology devices.

9. The device according to claim 1, further comprising means for establishing an internet connection between the setup server computer and a user terminal.

10. The device according to claim 7, further comprising a program configuration unit for configuring the user interface for a domestic technology device in dependence of the configuration data of the domestic technology device.

11. The device according to claim 10, wherein the setup server computer is configured to install the user interface generated in dependence of the configuration data in the domestic technology device.

12. The device according to claim 10, wherein the program configuration unit is provided to configure an internet access of the domestic technology device via the communication connection.

13. The device according to claim 7, wherein the communication connection is an internet or mobile telephony communication connection.

14. The device according to claim 7, wherein the setup server computer is configured to generate a form file and to transfer the form file to the user terminal via the internet or mobile telephony communication connection.

15. The device according to claim 10, wherein the setup server computer is provided to receive a form file supplemented by a user via the internet connection and to extract at least one user request characteristic from the form file, the program configuration unit configuring the operating program in dependence of the user request characteristic.

16. The device according to claim 7, further comprising a backup server computer which is configured to take over the function of the setup server computer in case the latter fails.

17. The device according to claim 7, further comprising a monitor computer for monitoring the function of the setup server computer and of a backup server computer.

18. The device according to claim 7, wherein the setup server computer is configured to inquire diagnostic data from the domestic technology device via the communication connection.

19. The device according to claim 7, further comprising a database comprising the memory unit.

20. The device according to claim 7, wherein at least one web server for providing internet forms for inputting configuration data.

21. The device according to claim 7 wherein the setup server computer is configured to transfer at least one website of a user interface available via a network to the domestic technology device via the communication connection.

22. A method for controlling and monitoring at least one domestic technology device, in particular a heating installation, wherein at least one configuration parameter for a user interface of the domestic technology device is generated in dependence of the configuration data of the domestic technology device in a user interface configuration step and the configuration parameter for the user interface is transferred to the domestic technology device via a communication connection in a transfer step,
the user interface configuration step being performed by a setup server computer which
receives identification data of the domestic technology device via an internet connection in an identification step, and
reads the configuration data of the domestic technology device from a memory unit at least partially in dependence of the identification data.
